(19) United States
(12) Patent Application Publication
(10) Pub. No.: US 2026/0103995 A1
(43) Pub. Date: Apr. 16, 2026

(54) TURBINE ENGINE HAVING A FAN SPEED SENSOR SYSTEM

(71) Applicant: General Electric Company, Evendale, OH (US)

(72) Inventors: Brandon W. Miller, Liberty Township, OH (US); Andrew Hudecki, Milford, OH (US); Eric Barre, Cincinnati, OH (US); Mark Wotzak, Chestnut Hill, MA (US); Arthur W. Sibbach, Boxford, MA (US)

(21) Appl. No.: 18/908,399

(22) Filed: Oct. 7, 2024

(51) Int. Cl. F01D 21/00; F01D 17/06; F02C 9/28

(52) U.S. Cl. CPC F01D 21/003; F01D 17/06; F02C 9/28; F05D 2220/36; F05D 2260/70

(57) ABSTRACT

A turbine engine includes a fan including a fan rotor assembly having a plurality of fan blades coupled to a fan disk, a fan frame that supports the fan, and a fan speed sensor system. The fan speed sensor system includes one or more fan speed sensors that sense a fan speed of the fan. The one or more fan speed sensors are positioned to sense the fan rotor assembly. A method of operating the turbine engine includes rotating the fan rotor assembly, sensing rotation of the fan rotor assembly with the one or more fan speed sensors, determining the fan speed of the fan based on the rotation of the fan rotor assembly, and controlling one or more components of the turbine engine based on the fan speed of the fan.

### TECHNICAL FIELD

The present disclosure relates generally to fan speed sensor systems for turbine engines.

### BACKGROUND

Turbine engines, for example, for an aircraft, generally include a fan and a turbo-engine arranged in flow communication with one another. Some turbine engines include speed sensors for sensing a rotational speed of one or more rotating components of the turbine engine.

### BRIEF DESCRIPTION OF THE DRAWINGS

The foregoing and other features and advantages will be apparent from the following, more particular, description of various exemplary embodiments, as illustrated in the accompanying drawings, wherein like reference numbers generally indicate identical, functionally similar, or structurally similar elements.

FIG. 1 is a schematic cross-sectional diagram of a turbine engine, taken along a longitudinal centerline axis of the turbine engine, according to the present disclosure.

FIG. 2 is a partial schematic cross-sectional diagram of the turbine engine of FIG. 1, taken at detail 2 in FIG. 1, with a fan speed sensor system, according to the present disclosure.

FIG. 3 is a partial schematic cross-sectional diagram of the turbine engine with a fan speed sensor system, according to another embodiment.

FIG. 4 is a schematic cross-sectional diagram of a turbine engine, taken along a longitudinal centerline axis of the turbine engine, according to another embodiment.

FIG. 5 is a partial schematic cross-sectional diagram of the turbine engine of FIG. 4, taken at detail 5 in FIG. 4, with a fan speed sensor system, according to the present disclosure.

FIG. 6 is a flowchart of a method of operating the fan speed sensor system of the turbine engine of FIG. 2, according to the present disclosure.

FIG. 7 is a flowchart of a method of removing one or more fan speed sensors of the fan speed sensor system of FIG. 2, according to the present disclosure.

FIG. 8 is a flowchart of a method of removing one or more fan speed sensors of the fan speed sensory system of FIG. 2, according to another embodiment.

### DETAILED DESCRIPTION

Features, advantages, and embodiments of the present disclosure are set forth or apparent from a consideration of the following detailed description, drawings, and claims. Moreover, the following detailed description is exemplary and intended to provide further explanation without limiting the disclosure as claimed.

Various embodiments of the present disclosure are discussed in detail below. While specific embodiments are discussed, this is done for illustration purposes only. A person skilled in the relevant art will recognize that other components and configurations may be used without departing from the present disclosure.

As used herein, the terms “first,” “second,” “third,” etc., may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “forward” and “aft” refer to relative positions within a turbine engine or vehicle, and refer to the normal operational attitude of the turbine engine or vehicle. For example, with regard to a turbine engine, forward refers to a position closer to an engine inlet and aft refers to a position closer to an engine nozzle or exhaust.

The terms “coupled,” “fixed,” “attached,” “connected,” and the like, refer to both direct coupling, fixing, attaching, or connecting, as well as indirect coupling, fixing, attaching, or connecting through one or more intermediate components or features, unless otherwise specified herein.

The singular forms “a,” “an,” and “the” include plural references unless the context clearly dictates otherwise.

As used herein, the terms “axial” and “axially” refer to directions and orientations that extend substantially parallel to a centerline of the turbine engine. Moreover, the terms “radial” and “radially” refer to directions and orientations that extend substantially perpendicular to the centerline of the turbine engine. In addition, as used herein, the terms “circumferential” and “circumferentially” refer to directions and orientations that extend arcuately about the centerline of the turbine engine.

As used herein, “slew rate” is a rate of change of a pitch of the fan blades.

As used herein, an “integral drive engine” or an “integral drive configuration” is a turbine engine having a gearbox assembly that transfers power from a turbine shaft to a fan shaft.

As used herein, a “fan rotor assembly” includes at least one of a fan shaft, a fan disk, fan blades, or a counterweight of a fan actuation system.

As used herein, the terms “sense” or “sensing” refer to a fan speed sensor detecting the fan rotor assembly and generating a signal indicative of a rotational speed, also referred to as a fan speed, of a fan, and sends the fan speed (i.e., the signal indicative of the fan speed) to a controller (e.g., either within the fan speed sensor or remote from the fan speed sensor) for determining the fan speed based on the signal indicative of the fan speed. For example, the fan speed sensors herein can be magneto-resistive sensors, inductive sensors, variable reluctance sensors, Hall effect sensors, or optical sensors. The fan speed sensor can detect a reference point on the fan rotor assembly and a change in time between the reference point passing the fan speed sensor in order to generate the signal indicative of the fan speed.

As used herein, the terms “low,” “mid” (or “mid-level”), and “high,” or their respective comparative degrees (e.g., “lower” and “higher”, where applicable), when used with compressor, combustor, turbine, shaft, fan, or turbofan engine components, each refers to relative pressures, relative speeds, relative temperatures, or relative power outputs within an engine unless otherwise specified. For example, a “low-power” setting defines the engine or the combustor configured to operate at a power output lower than a “high-power” setting of the engine or the combustor, and a “mid-level power” setting defines the engine or the combustor configured to operate at a power output higher than a “low-power” setting and lower than a “high-power” setting. The terms “low,” “mid” (or “mid-level”) or “high” in such aforementioned terms may additionally, or alternatively, be understood as relative to minimum allowable speeds, pressures, or temperatures, or minimum or maximum allowable speeds, pressures, or temperatures relative to normal, desired, steady state, etc., operation of the engine. A mission cycle for a turbofan engine includes, for example, a low-power operation, a mid-level power operation, and a high-power operation. Low-power operation includes, for example, engine start, idle, taxiing, and approach. Mid-level power operation includes, for example, cruise. High-power operation includes, for example, takeoff and climb.

The various power levels of the turbofan engine are defined as a percentage of a sea level static (SLS) maximum engine rated thrust. Low power operation includes, for example, less than thirty percent (30%) of the SLS maximum engine rated thrust of the turbofan engine. Mid-level power operation includes, for example, thirty percent (30%) to eighty-five percent (85%) of the SLS maximum engine rated thrust of the turbofan engine. High-power operation includes, for example, greater than eighty-five percent (85%) of the SLS maximum engine rated thrust of the turbofan engine. The values of the thrust for each of the low power operation, the mid-level power operation, and the high-power operation of the turbofan engine are exemplary only, and other values of the thrust can be used to define the low power operation, the mid-level power operation, and the high-power operation.

The present disclosure provides for turbine engines that have a fan speed sensor system and a gearbox assembly, also referred to as a power gearbox, that transfers power from a turbine shaft of the turbine engine to a fan (e.g., a fan shaft or a propeller shaft). Such turbine engines are referred to as integral drive engines. Integral drive engines differ from direct drive engines that directly couple the fan shaft to the turbine shaft without the use of a gearbox. The fan of direct drive engines rotates at a same speed as the turbine shaft. The fan of integral drive engines, however, rotates at a lower speed than the turbine shaft due to the reduction of speed through the power gearbox. The fan speed sensor system has one or more fan speed sensors that sense a fan speed of the fan.

Some turbine engines include a lubricant sump, also referred to as an oil wetted bearing sump, that collects and supplies lubricant (e.g., oil) to one or more bearings of the turbine engine. The available space, the desirable space, or the volume available in that part of the turbine engine for the lubricant sump is less for integral drive engines compared to direct drive engines. This is due to the gearbox assembly in that part of the turbine engine that reduces the amount of space available compared to direct drive engines. The available space in that part of the turbine engine cannot be simply scaled up without affecting other components of the turbine engine. For example, increasing the size of the lubricant sump affects the overall length of the turbine engine, the fan radius ratio of the fan, the fan diameter of the fan, or a combination thereof. The fan speed sensors are typically positioned through the lubricant sump in direct drive engines due to having more space in that part of the turbine engine for fitting the fan speed sensors as compared to integral drive engines. The fan speed sensors, however, are unable to be positioned through the lubricant sump in integral drive engines without increasing the amount of space available in that part of the engine (e.g., as given by at least one of the overall length of the turbine engine, the fan radius ratio, or the fan diameter), and affecting dynamics and performance of the fan and the turbine engine.

In particular, increasing the size of the lubricant sump requires the fan hub radius to be increased in order to increase the radial space under the fan available for the lubricant sump, and increases the fan radius ratio (i.e., the ratio of the fan hub radius to the fan blade radius). However, increasing the fan hub radius sacrifices aerodynamic performance as there is less surface area of the fan blades moving air therethrough (e.g., less surface area of the fan blades is disposed in the flow path of the incoming air). The fan diameter also affects the volume available for the fan speed sensors underneath the fan. Decreasing the fan diameter provides for more space underneath the fan by increasing the radial spacing between blades and within the volume circumscribed by the fan blades, but decreases the fan tip speed for a given rotational speed, and, thus, reduces the aerodynamic performance of the fan. Increasing the fan blade diameter increases the aerodynamic performance of the fan, but the radial spacing between blades and within the volume circumscribed by the fan blades (e.g., within the space beneath the fan) decreases, and, thus, decreasing the volume beneath the fan and providing less space for the fan speed sensors underneath the fan. Some turbine engines also include a fan actuation system that further reduces the amount of space available for the fan speed sensor system in that part of the engine. Further, some current fan speed sensor systems utilize oil-wetted sensors that are disposed within the sump, but such sensors provide less accuracy as compared to sensors that are able to directly sense a component. Sensors disposed in the sump or in other parts of the engine for sensing the fan speed (e.g., positioned to sense bearings) are difficult to remove from the turbine engine, as other components (e.g., the bearings, components of the sump, etc.) need to be removed in order to remove the fan speed sensors, for example, for maintenance or for replacement.

Accordingly, the present disclosure provides for a fan speed sensor system that includes one or more fan speed sensors positioned to sense the fan rotor assembly (e.g., the fan disk) of the fan for sensing the fan speed. In this way, the one or more fan speed sensors are positioned outside (e.g., radially outward) of the lubricant sump, and the lubricant sump does not need to be scaled up. Thus, the fan speed sensor system of the present disclosure can fit within the tight space of the integral drive engine without affecting at least one of the overall length of the turbine engine, the fan radius ratio, or the fan diameter. The fan speed sensors are positioned aft of the fan disk, between the fan disk and the fan frame. In some embodiments, the fan speed sensors can be positioned to sense the fan rotor assembly including at least one of the fan shaft, the fan disk, part of the fan blades, or a counterweight of the fan actuation system. The fan speed sensors include a cable that extends through the fan frame and into the outer casing. In some embodiments, the cable extends through an inlet guide vane of the turbine engine.

The present disclosure also provides for a method of removing the fan speed sensors by removing one or more fan blades, opening the fan frame, and removing the fan speed sensors from the turbine engine through the fan frame. In some embodiments, the method includes removing one or mor fan blades to open an aperture in the fan, and removing the fan speed sensors from the turbine engine through the aperture. In this way, the removal of the fan speed sensors is simpler and requires removing fewer components of the turbine engine as compared to fan speed sensors that are positioned through the lubricant sump in direct drive engines.

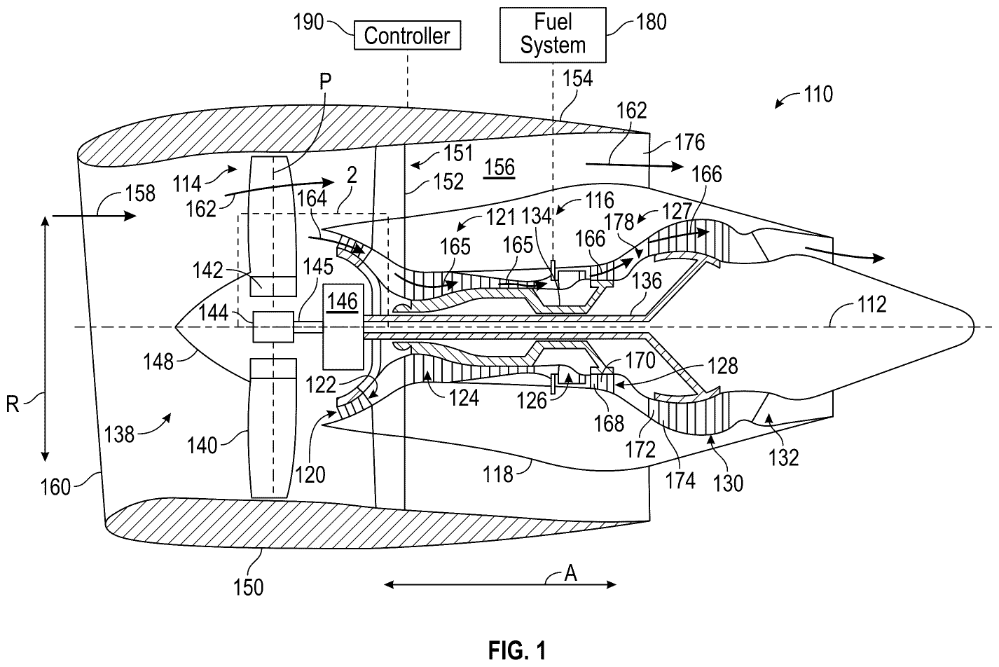

Referring now to the drawings, FIG. 1 is a schematic cross-sectional diagram of a turbine engine 110, taken along a longitudinal centerline axis 112 of the turbine engine 110, according to an embodiment of the present disclosure. As shown in FIG. 1, the turbine engine 110 defines an axial direction A (extending parallel to the longitudinal centerline axis 112 provided for reference) and a radial direction R that is normal to the axial direction A. In general, the turbine engine 110 includes a fan assembly 114 and a turbo-engine 116 disposed downstream from the fan assembly 114.

The turbo-engine 116 includes, in serial flow relationship, a compressor section 121, a combustor 126, and a turbine section 127. The turbo-engine 116 depicted is substantially enclosed within a core cowl 118 (e.g., an outer casing) that is substantially tubular and defines a core inlet 120 having an annular shape that is annular about the longitudinal centerline axis 112. As schematically shown in FIG. 1, the compressor section 121 includes a booster or a low-pressure (LP) compressor 122 followed downstream by a high-pressure (HP) compressor 124. The combustor 126 is downstream of the compressor section 121. The turbine section 127 is downstream of the combustor 126 and includes a high-pressure (HP) turbine 128 followed downstream by a low-pressure (LP) turbine 130, also referred to as a power turbine. The turbo-engine 116 also includes a core exhaust nozzle 132 that is downstream of the turbine section 127. The turbo-engine 116 further includes a high-pressure (HP) shaft 134, also referred to as a high-speed shaft, that drivingly connects the HP turbine 128 to the HP compressor 124. The HP turbine 128 and the HP compressor 124 rotate in unison through the HP shaft 134. The turbo-engine 116 includes a low-pressure (LP) shaft 136, also referred to as a low-speed shaft, that drivingly connects the LP turbine 130 to the LP compressor 122. The LP turbine 130 and the LP compressor 122 rotate in unison through the LP shaft 136. The compressor section 121, the combustor 126, the turbine section 127, and the core exhaust nozzle 132 together define a core air flow path.

For the embodiment depicted in FIG. 1, the fan assembly 114 includes a fan 138 (e.g., a variable pitch fan) having a plurality of fan blades 140 coupled to a fan disk 142 in a spaced apart manner. As depicted in FIG. 1, the fan blades 140 extend outwardly from the fan disk 142 generally along the radial direction R. Each fan blade 140 is rotatable relative to the fan disk 142 about a pitch axis P by virtue of the fan blades 140 being operatively coupled to a fan actuation system 144 configured to collectively vary the pitch of the fan blades 140 in unison, as detailed further below. The fan actuation system 144 is disposed within a fan hub 148. The fan blades 140, the fan disk 142, and the fan actuation system 144 are together rotatable about the longitudinal centerline axis 112 via a fan shaft 145 that is powered by the LP shaft 136 across a power gearbox, also referred to as a gearbox assembly 146 (i.e., an integral drive configuration).

The gearbox assembly 146 is shown schematically in FIG. 1. The gearbox assembly 146 includes a plurality of gears for adjusting the rotational speed of the fan shaft 145 and, thus, the fan 138 relative to the LP shaft 136. The gearbox assembly 146 has a gear ratio in a range of 3.5:1 to 5:1 for a ducted engine (e.g., the turbine engine 110). The LP shaft 136, the gearbox assembly 146, and the fan shaft 145 are disposed in an in-line configuration such that the LP shaft 136, the gearbox assembly 146, and the fan shaft 145 are coaxial and are each disposed about the longitudinal centerline axis 112. The in-line configuration helps to reduce the space needed within the turbine engine 110 for the gearbox assembly 146 and allows a greater amount of torque to be transferred from the LP shaft 136 to the fan shaft 145 through the gearbox assembly 146 as compared to turboprop engines in which the gearbox assembly is typically disposed in a stepped configuration and is not coaxial with the LP shaft and the fan shaft.

Referring still to the exemplary embodiment of FIG. 1, the fan disk 142 is covered by a fan hub 148 that rotates and is aerodynamically contoured to promote an airflow through the plurality of fan blades 140. In addition, the fan assembly 114 includes an annular fan casing or a nacelle 150 that circumferentially surrounds the fan 138 and at least a portion of the turbo-engine 116. In this way, the turbine engine 110 is a ducted engine. The nacelle 150 is supported relative to the turbo-engine 116 by a fan frame 151 having a plurality of fan guide vanes 152, also referred to as outlet guide vanes, that is spaced circumferentially about the nacelle 150. Moreover, a downstream section 154 of the nacelle 150 extends over an outer portion of the turbo-engine 116 to define a bypass airflow passage 156 therebetween.

During operation of the turbine engine 110, a volume of air 158 enters the turbine engine 110 through an inlet 160 of the nacelle 150 or the fan assembly 114. As the volume of air 158 passes across the fan blades 140, a first portion of air, referred to as bypass air 162, is directed or routed into the bypass airflow passage 156, and a second portion of air, referred to as core air 164, is directed or is routed into the upstream section of the core air flow path, or, more specifically, into the core inlet 120 of the LP compressor 122. The ratio between the bypass air 162 and the core air 164 is commonly known as a bypass ratio. The pressure of the core air 164 is then increased by the LP compressor 122 to produce compressed air 165, and the compressed air 165 is routed through the HP compressor 124 and into the combustor 126, where the compressed air 165 is mixed with fuel and burned to generate combustion gases 166.

The combustion gases 166 are routed into the HP turbine 128 and expanded through the HP turbine 128 where a portion of thermal energy and kinetic energy from the combustion gases 166 is extracted via one or more stages of HP turbine stator vanes 168 that are coupled to the core cowl 118 and HP turbine rotor blades 170 that are coupled to the HP shaft 134. This causes the HP shaft 134 to rotate, supporting operation of the HP compressor 124 (e.g., a self-sustaining cycle). In this way, the combustion gases 166 do work in the HP turbine 128 to cause the HP turbine rotor blades 170 (and the HP shaft 134) to rotate at a sufficient rate to maintain the compression ratio of the HP compressor 124 (e.g., a self-sustaining cycle). The combustion gases 166 are then routed into the LP turbine 130 and expanded through the LP turbine 130. Here, a second portion of the thermal energy and the kinetic energy is extracted from the combustion gases 166 via one or more stages of LP turbine stator vanes 172 that are coupled to the core cowl 118 and LP turbine rotor blades 174 that are coupled to the LP shaft 136. This causes the LP shaft 136 to rotate, supporting operation of the LP compressor 122 and rotation of the fan 138 via the gearbox assembly 146 (e.g., a self-sustaining cycle). In this way, the combustion gases 166 do work in the LP turbine 130 to cause the LP turbine blades 174 (and the LP shaft 136) to rotate.

The combustion gases 166 are subsequently routed through the core exhaust nozzle 132 of the turbo-engine 116 to provide propulsive thrust. Simultaneously, the bypass air 162 is directed through the bypass airflow passage 156 before being exhausted from a fan exhaust nozzle 176 of the turbine engine 110, also providing propulsive thrust. The HP turbine 128, the LP turbine 130, and the core exhaust nozzle 132 at least partially define a hot gas path 178 for routing the combustion gases 166 through the turbo-engine 116.

The turbine engine 110 includes a fuel system 180 for providing the fuel to the combustor 126. For example, the fuel system 180 can include a fuel tank for storing the fuel, one or more fuel lines in flow communication with the fuel tank and the combustor 126, and a fuel pump for delivering the fuel from the fuel tank to the combustor 126 through the one or more fuel lines.

The turbine engine 110 includes a controller 190. The controller 190 is in communication with the turbine engine 110 for controlling aspects of the turbine engine 110. For example, the controller 190 is in two-way communication with the turbine engine 110 for receiving signals from various sensors (e.g., the speed sensors detailed herein) and control systems of the turbine engine 110 (e.g., the fuel system 180) and for controlling components of the turbine engine 110 (e.g., the fan blades 140), as detailed further below. The controller 190, or components thereof, may be located onboard the turbine engine 110, onboard the aircraft, or can be located remote from each of the turbine engine 110 and the aircraft. The controller 190 can be a Full Authority Digital Engine Control (FADEC) that controls aspects of the turbine engine 110.

The controller 190 may be a standalone controller or may be part of an engine controller to operate various systems of the turbine engine 110. In this embodiment, the controller 190 is a computing device having one or more processors and a memory. The one or more processors can be any suitable processing device, including, but not limited to, a microprocessor, a microcontroller, an integrated circuit, a logic device, a programmable logic controller (PLC), an application specific integrated circuit (ASIC), or a Field Programmable Gate Array (FPGA). The memory can include one or more computer-readable media, including, but not limited to, non-transitory computer-readable media, a computer readable non-volatile medium (e.g., a flash memory), a RAM, a ROM, hard drives, flash drives, or other memory devices.

The memory can store information accessible by the one or more processors, including computer-readable instructions that can be executed by the one or more processors. The instructions can be any set of instructions or a sequence of instructions that, when executed by the one or more processors, cause the one or more processors and the controller 190 to perform operations. The controller 190 and, more specifically, the one or more processors are programmed or configured to perform these operations, such as the operations discussed further below. In some embodiments, the instructions can be executed by the one or more processors to cause the one or more processors to complete any of the operations and functions for which the controller 190 is configured, as will be described further below. The instructions can be software written in any suitable programming language or can be implemented in hardware. Additionally, or alternatively, the instructions can be executed in logically or virtually separate threads on the processors. The memory can further store data that can be accessed by the one or more processors.

The technology discussed herein makes reference to computer-based systems and actions taken by, and information sent to and from, computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

The turbine engine 110 depicted in FIG. 1 is by way of example only. In other exemplary embodiments, the turbine engine 110 may have other suitable configurations. In other exemplary embodiments, any other suitable number or configuration of compressors, turbines, shafts, or a combination thereof may be provided. In still other exemplary embodiments, aspects of the present disclosure may be incorporated into other suitable turbine engines, such as, for example, propfan (e.g., unducted fan) engines, turboprop engine, or the like.

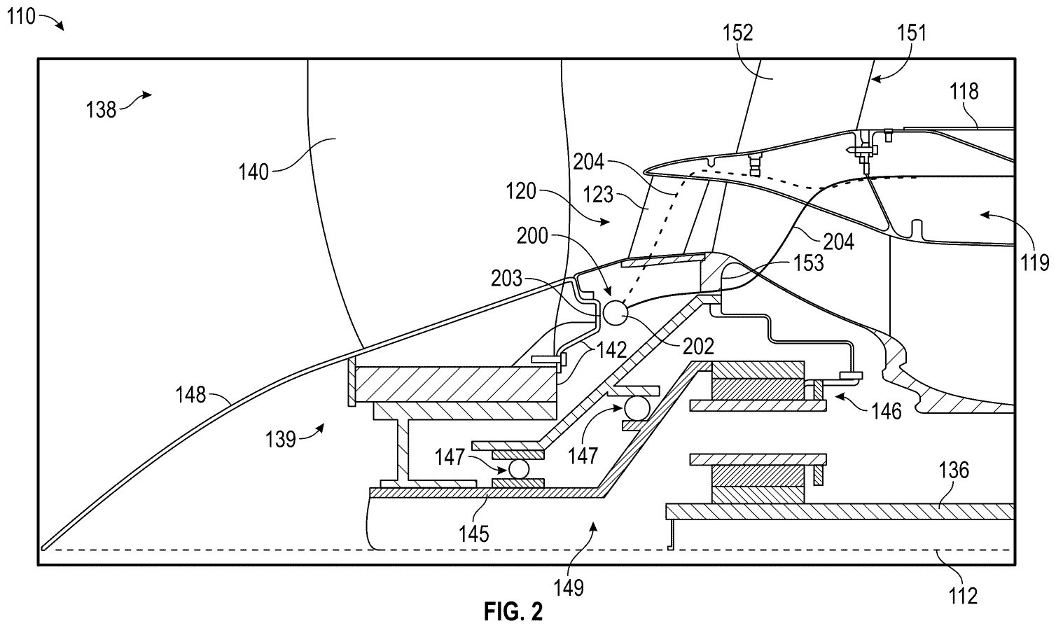

FIG. 2 is a partial schematic cross-sectional diagram of the turbine engine 110, taken at detail 2 in FIG. 1, with a fan speed sensor system 200, according to the present disclosure. As shown in FIG. 2, the core cowl 118 includes a hollow interior 119. The core inlet 120 includes an inlet guide vane 123 that guides the flow of the core air 164 (FIG. 1) into the turbo-engine 116 (FIG. 1). The fan frame 151 includes a fan frame flange 153. The gearbox assembly 146 is coupled to the fan frame flange 153 such that the fan frame 151 supports the gearbox assembly 146 via the fan frame flange 153. The fan frame flange 153 also rotationally supports the fan shaft 145 via one or more bearings 147. The turbine engine 110 also includes a lubricant sump 149 that is positioned about the gearbox assembly 146 for collecting lubricant that is supplied to the one or more bearings 147 and to the gearbox assembly 146. In particular, the lubricant sump 149 is positioned radially within the fan frame 151. The lubricant sump 149 is an oil wetted bearing sump. The fan 138 includes a fan rotor assembly 139 that includes the fan disk 142.

The turbine engine 110 also includes the fan speed sensor system 200. The fan speed sensor system 200 includes one or more fan speed sensors 202 (shown schematically in FIG. 2) and the controller 190 (FIG. 1). The one or more fan speed sensors 202 sense a rotational speed, also referred to as a fan speed, of the fan 138, and sends the fan speed (i.e., a fan speed signal) to the controller 190. For example, the one or more fan speed sensors 202 can be magneto-resistive sensors, inductive sensors, variable reluctance sensors, Hall effect sensors, or optical sensors. The one or more fan speed sensors 202 can include any type of fan speed sensor for sensing the fan speed of the fan 138.

The one or more fan speed sensors 202 are positioned to sense the fan rotor assembly 139 (e.g., fan disk 142). In particular, the one or more fan speed sensors 202 sense a rotational speed of the fan rotor assembly 139. The rotational speed of the fan rotor assembly 139 corresponds to the fan speed. The one or more fan speed sensors 202 are radially outward of the lubricant sump 149 such that the one or more fan speed sensors 202 are positioned outside of the lubricant sump 149. In particular, the one or more fan speed sensors 202 are positioned aft of the fan rotor assembly 139 (e.g., the fan disk 142) and are axially between the fan rotor assembly 139 and the fan frame 151 (e.g., the fan frame flange 153). In this way, the one or more fan speed sensors 202 are positioned axially forward of the gearbox assembly 146. Thus, the one or more fan speed sensors 202 are oriented to sense a reference point 203 on an aft side of the fan rotor assembly 139. For example, the reference point 203 is on the aft side of the fan disk 142 or on the aft side of a rotating part connected to the fan disk 142. The reference point 203 includes at least one of a phonic wheel coupled to the fan rotor assembly 139, a magnetic pickup coupled to the fan rotor assembly 139, or a visual reference point on the fan rotor assembly 139. The one or more fan speed sensors 202 sense the reference point 203 and generate a signal indicative of the fan speed based on the sensed reference point 203, as detailed further below.

The one or more fan speed sensors 202 each includes a cable 204 in communication with the controller 190 (FIG. 1) for sending data to the controller 190. The cable 204 extends from the one or more fan speed sensors 202 through the fan frame 151 and through the core cowl 118 (e.g., into the hollow interior 119). In some embodiments (as shown by dashed lines in FIG. 2), the cable 204 extends from the one or more fan speed sensors 202 through the inlet guide vane 123 and through the core cowl 118. In some embodiments, the one or more fan speed sensors 202 can be wireless sensors such that the cable 204 is omitted and the data measured by the one or more fan speed sensors 202 is sent to the controller 190 wirelessly (e.g., via Wi-Fi, Bluetooth, cellular, or the like).

In operation, the fan rotor assembly 139 (e.g., the fan disk 142) rotates and the one or more fan speed sensors 202 sense the fan speed and a direction of rotation of the fan 138 based on the rotation of the fan rotor assembly 139. In particular, the one or more fan speed sensors 202 sense the reference point 203. When reference point 203 is a phonic wheel and the one or more fan speed sensors 202 are magneto-resistive sensors, or the like, the one or more fan speed sensors 202 sense a change in magnetic resistance as the fan rotor assembly 139 (e.g., the phonic wheel) rotates and generates a signal indicative of the fan speed (e.g., a voltage or an electronic signal) in response to the change in magnetic resistance. The one or more fan speed sensors 202 send the signal indicative of the fan speed to the controller 190, and the controller 190 determines the fan speed based on the signal indicative of the fan speed (e.g., based on the change in magnetic resistance). In some embodiments, the controller 190, a portion of the controller 190, or another controller, can be integrated within the one or more fan speed sensors 202 such that the one or more fan speed sensors 202 determine the fan speed based on the change in magnetic resistance.

When the reference point 203 is a magnetic pickup, the one or more fan speed sensors 202 sense a magnetic field of the magnetic pickup as the magnetic pickup passes by the one or more fan speed sensors 202. The one or more fan speed sensors 202 generate a signal indicative of the fan speed (e.g., a voltage or an electronic signal) based on the sensed magnetic field and send the output voltage to the controller 190. The controller 190, a portion thereof, or another controller, determines the fan speed based on the signal indicative of the fan speed (e.g., based on the magnetic field). When the reference point 203 is a visual reference point, the one or more fan speed sensors 202 are optical sensors and sense the visual reference point as the visual reference point passes by the one or more fan speed sensors 202. The one or more fan speed sensors 202 measure light reflected, or interrupted, by the visual reference point as the visual reference point passes by the one or more fan speed sensors 202. The one or more fan speed sensors 202 generate a signal indicative of the fan speed based on light reflected, or interrupted, by the visual reference point (e.g., an electronic signal) and send the signal indicative of the fan speed to the controller 190 (e.g., a portion of the controller 190 or another controller). The controller 190 determines the fan speed based on the signal indicative of the fan speed. In some embodiments, the cable 204 is a fiber optic cable that is positioned to sense the reference point 203, and the hardware components (e.g., controller, etc.) of the one or more fan speed sensors 202 are positioned away from the fan rotor assembly 139 in an area of the turbine engine 110 that is accessible to a user.

The fan speed is representative of a fan blade tip speed of the fan blades 140. The fan blade tip speed must be kept sub sonic to prevent a detachment of the airflow from the fan blade 140. As such, the rotational speed of the fan 138 is directly affected by the diameter of the fan 138. In general, the fan blade tip speed decreases as the diameter of the fan 138 increases. For example, for a fan with a diameter of about seventy-eight inches (78 inches), the fan speed (maximum speed) is about three thousand nine hundred rotations per minute (3,900 RPM). For a fan with a diameter of about one hundred thirty-four inches (134 inches), the fan speed is about two thousand four hundred rotations per minute (2,400 RPM). The values of diameter and fan speed disclosed herein are exemplary only.

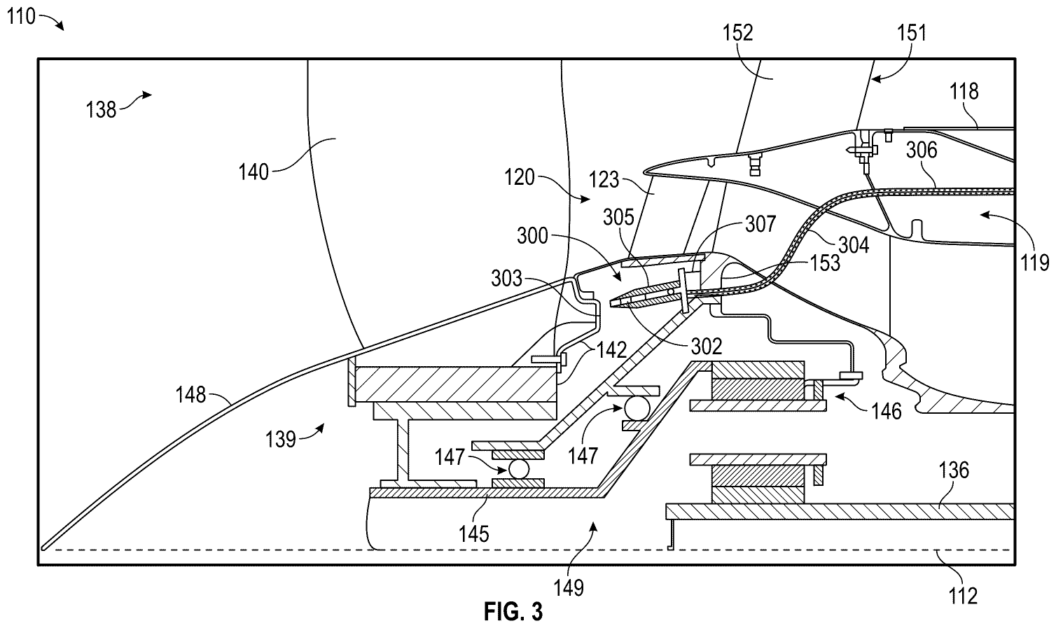

FIG. 3 is a partial schematic cross-sectional diagram of the turbine engine 110 with a fan speed sensor system 300, according to another embodiment. The fan speed sensor system 300 is substantially similar to the fan speed sensor system 200 of FIG. 2. The same or similar reference numerals will be used for components of the fan speed sensor system 300 that are the same as or similar to the components of the fan speed sensor system 200 discussed above, unless stated otherwise. The description of these components above also applies to this embodiment, and a detailed description of these components is omitted here.

The fan speed sensor system 300 includes one or more fan speed sensors 302 that sense a reference point 303 on the fan rotor assembly 139 and that each has a cable 304. As shown in FIG. 3, fan speed sensor system 300 includes a sensor housing 305 and a cable guide tube 306. The one or more fan speed sensors 302 are disposed within the sensor housing 305 and are oriented to sense the fan rotor assembly 139 (e.g., the reference point 303). The sensor housing 305 is removably coupled to the fan frame 151 (e.g., the fan frame flange 153) by one or more removable fasteners 307. The one or more removable fasteners 307 can include any type of removable fastener, such as, for example, bolts, screws, snap fasteners, pins, or the like.

The cable guide tube 306 extends through the core cowl 118 and through the fan frame 151 (e.g., the fan frame flange 153) to the sensor housing 305. The cable 304 extends through the cable guide tube 306. The one or more fan speed sensors 302 and the cable 304 can be removed through the cable guide tube 306 while the cable guide tube 306 (and the sensor housing 305) remains in place. The one or more fan speed sensors 302 and the cable 304 can be inserted through the cable guide tube 306 and the one or more fan speed sensors 302 are disposed in the sensor housing 305 when the one or more fan speed sensors 302 are installed.

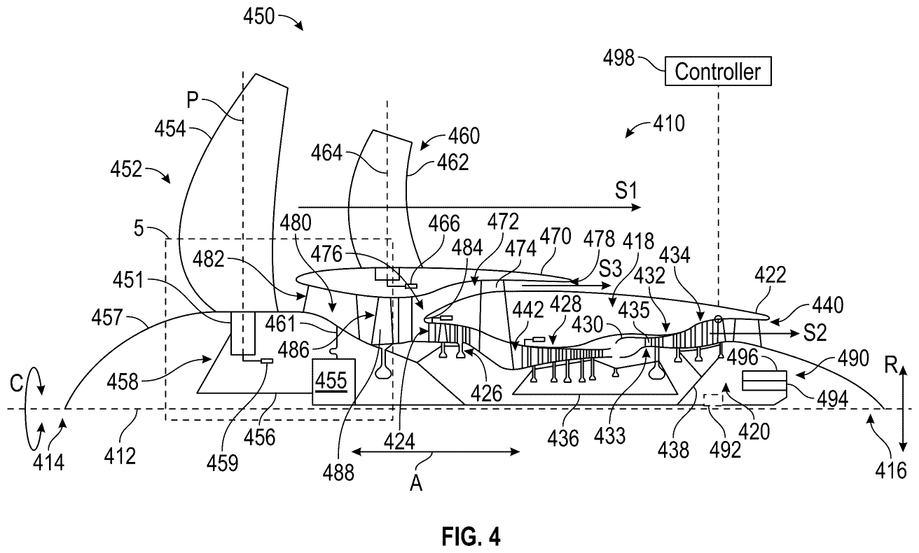

FIG. 4 is a schematic cross-sectional diagram of a turbine engine 410, taken along a longitudinal centerline axis 412 of the turbine engine 410, according to another embodiment. The turbine engine 410 is an unducted fan engine or an open fan engine. The turbine engine 410 is a “three-stream engine” in that its architecture provides three distinct streams (labeled S1, S2, and S3) of thrust-producing airflow during operation, as detailed further below.

As shown in FIG. 4, the turbine engine 410 defines an axial direction A, a radial direction R, and a circumferential direction C. Moreover, the turbine engine 410 defines the longitudinal centerline axis 412 that extends along the axial direction A. In general, the axial direction A extends parallel to the longitudinal centerline axis 412, the radial direction R extends outward from, and inward to, the longitudinal centerline axis 412 in a direction orthogonal to the axial direction A, and the circumferential direction C extends three hundred sixty degrees (360°) around the longitudinal centerline axis 412. The turbine engine 410 extends between a forward end 414 and an aft end 416, e.g., along the axial direction A.

The turbine engine 410 includes a turbo-engine 420 and a fan assembly 450 positioned upstream thereof. Generally, the turbo-engine 420 includes a compressor section, a combustion section, a turbine section, and an exhaust section. Particularly, as shown in FIG. 4, the turbo-engine 420 includes an engine core 418 and a core cowl 422 that annularly surrounds the turbo-engine 420. The turbo-engine 420 and the core cowl 422 define a core inlet 424 having an annular shape that is annular about the longitudinal centerline axis 412. The core cowl 422 further encloses and supports a low-pressure (LP) compressor 426 (also referred to as a booster) for pressurizing the air that enters the turbo-engine 420 through the core inlet 424. A high-pressure (HP) compressor 428 receives pressurized air from the LP compressor 426 and further increases the pressure of the air. The pressurized air flows downstream to a combustor 430 where fuel is injected into the pressurized air and ignited to raise the temperature and the energy level of the pressurized air, generating combustion gases.

The combustion gases flow from the combustor 430 downstream to a high-pressure (HP) turbine 432. The HP turbine 432 drives the HP compressor 428 through a first shaft, also referred to as a high-pressure (HP) shaft 436 (also referred to as a “high-speed shaft”). In this regard, the HP turbine 432 is drivingly coupled with the HP compressor 428. Together, the HP compressor 428, the combustor 430, and the HP turbine 432 define the engine core 418. The combustion gases then flow to a power turbine or a low-pressure (LP) turbine 434. The LP turbine 434 drives the LP compressor 426 and components of the fan assembly 450 through a second shaft, also referred to as a low-pressure (LP) shaft 438 (also referred to as a “low-speed shaft”). In this regard, the LP turbine 434 is drivingly coupled with the LP compressor 426 and components of the fan assembly 450. The LP shaft 438 is coaxial with the HP shaft 436 in the embodiment of FIG. 4. After driving each of the HP turbine 432 and the LP turbine 434, the combustion gases exit the turbo-engine 420 through a core exhaust nozzle 440. The turbo-engine 420 defines a core flowpath, also referred to as a core duct 442, that extends between the core inlet 424 and the core exhaust nozzle 440. The core duct 442 is an annular duct positioned generally inward of the core cowl 422 along the radial direction R.

The fan assembly 450 includes a fan 452, also referred to as a primary fan. For the embodiment of FIG. 4, the fan 452 is an open rotor fan, also referred to as an unducted fan. However, in other embodiments, the fan 452 may be ducted, e.g., by a fan casing or a nacelle circumferentially surrounding the fan 452, similar to the embodiment of FIG. 1. The fan 452 includes a plurality of fan blades 454 (only one shown in FIG. 4) that extends in the radial direction R. The plurality of fan blades 454 is rotatable about the longitudinal centerline axis 412 via a fan shaft 456. As shown in FIG. 4, the fan shaft 456 is coupled with the LP shaft 438 via a speed reduction gearbox or a power gearbox, also referred to as a gearbox assembly 455, e.g., in an integral drive configuration.

The gearbox assembly 455 is shown schematically in FIG. 4. The gearbox assembly 455 includes a plurality of gears for adjusting the rotational speed of the fan shaft 456 and, thus, the fan 452 relative to the LP shaft 438 to a more efficient rotational fan speed. The gearbox assembly may have a gear ratio of 4:1 to 12:1, or 7:1 to 12:1, or 4:1 to 10:1, or 5:1 to 9:1, or 6:1 to 9:1, and may be configured in an epicyclic star or a planet gear configuration. Preferably, the gearbox assembly has a gear ratio of 4:1 to 10:1 for an unducted fan engine (e.g., the turbine engine 410). The gearbox may be a single stage gearbox or a compound gearbox (e.g., having a plurality of stages).

The fan blades 454 can be arranged in equal spacing around the longitudinal centerline axis 412. Each fan blade 454 extends outwardly from a fan disk 451 generally along the radial direction R. The fan disk 451 is covered by a fan hub 457 that is rotatable and aerodynamically contoured to promote an airflow through the plurality of fan blades 454. Each of the plurality of fan blades 454 defines a pitch axis P. For the embodiment of FIG. 4, each of the plurality of fan blades 454 of the fan 452 is rotatable about their respective pitch axis P, e.g., in unison with one another. A fan actuation system 458 controls one or more actuators 459 to pitch the fan blades 454 about their respective pitch axis P. The fan actuation system 458 is disposed within the fan hub 457.

The fan assembly 450 further includes a fan frame 460 that includes a fan frame flange 461 and a plurality of fan guide vanes 462 (only one shown in FIG. 4) disposed around the longitudinal centerline axis 412. For the embodiment of FIG. 4, the plurality of fan guide vanes 462 is not rotatable about the longitudinal centerline axis 412. The plurality of fan guide vanes 462 can be unshrouded as shown in FIG. 4 or can be shrouded, e.g., by an annular shroud spaced outward from the tips of the fan guide vanes 462 along the radial direction R. Each of the plurality of fan guide vanes 462 defines a vane pitch axis 464. For the embodiment of FIG. 4, each of the plurality of fan guide vanes 462 is rotatable about their respective vane pitch axis 464, e.g., in unison with one another. One or more actuators 466 are controlled to pitch the plurality of fan guide vanes 462 about their respective vane pitch axis 464. In other embodiments, each of the plurality of fan guide vanes 462 is fixed or is unable to be pitched about the vane pitch axis 464. The plurality of fan guide vanes 462 is mounted to a fan cowl 470.

The fan cowl 470 annularly encases at least a portion of the core cowl 422 and is generally positioned outward of the core cowl 422 along the radial direction R. Together, the fan cowl 470 and the core cowl 422 define an outer casing of the turbine engine 410. Particularly, a downstream section of the fan cowl 470 extends over a forward portion of the core cowl 422 to define a fan flowpath, also referred to as a fan duct 472. Incoming air enters through the fan duct 472 through a fan duct inlet 476 and exits through a fan exhaust nozzle 478 to produce propulsive thrust. The fan duct 472 is an annular duct positioned generally outward of the core duct 442 along the radial direction R. The fan cowl 470 and the core cowl 422 are connected together and supported by a plurality of struts 474 (only one shown in FIG. 4) that extends substantially radially and are circumferentially spaced about the longitudinal centerline axis 412. The plurality of struts 474 is each aerodynamically contoured to direct air flowing thereby. Other struts, in addition to the plurality of struts 474, can be used to connect and to support the fan cowl 470 and the core cowl 422.

The turbine engine 410 also defines or includes an inlet duct 480. The inlet duct 480 extends between an engine inlet 482 and the core inlet 424 and the fan duct inlet 476. The engine inlet 482 is defined generally at the forward end of the fan cowl 470 and is positioned between the fan 452 and the fan guide vanes 462 along the axial direction A. The inlet duct 480 is an annular duct that is positioned inward of the fan cowl 470 along the radial direction R. Air flowing downstream along the inlet duct 480 is split, not necessarily evenly, into the core duct 442 and the fan duct 472 by a splitter 484 of the core cowl 422. The inlet duct 480 is wider than the core duct 442 along the radial direction R. The inlet duct 480 is also wider than the fan duct 472 along the radial direction R.

The fan assembly 450 also includes a mid-fan 486. The mid-fan 486 includes a plurality of mid-fan blades 488 (only one shown in FIG. 4). The plurality of mid-fan blades 488 is rotatable, e.g., about the longitudinal centerline axis 412. The mid-fan 486 is drivingly coupled with the LP turbine 434 via the LP shaft 438. The plurality of mid-fan blades 488 can be arranged in equal circumferential spacing about the longitudinal centerline axis 412. The plurality of mid-fan blades 488 is annularly surrounded (e.g., ducted) by the fan cowl 470. In this regard, the mid-fan 486 is positioned inward of the fan cowl 470 along the radial direction R. The mid-fan 486 is positioned within the inlet duct 480 upstream of both the core duct 442 and the fan duct 472. A ratio of a span of a fan blade 454 to that of a mid-fan blade 488 (a span is measured from a root to a tip of the respective blade) is greater than two and less than ten to achieve the desired benefits of the third stream (S3), particularly, the additional thrust the third stream (S3) offers to the engine, which can enable a smaller diameter fan blade 454.

Accordingly, air flowing through the inlet duct 480 flows across the plurality of mid-fan blades 488 and is accelerated downstream thereof. At least a portion of the air accelerated by the mid-fan blades 488 flows into the fan duct 472 and is ultimately exhausted through the fan exhaust nozzle 478 to produce propulsive thrust. Also, at least a portion of the air accelerated by the plurality of mid-fan blades 488, flows into the core duct 442, and is ultimately exhausted through the core exhaust nozzle 440 to produce propulsive thrust. Generally, the mid-fan 486 is a compression device positioned downstream of the engine inlet 482. The mid-fan 486 is operable to accelerate air into the fan duct 472, also referred to as a secondary bypass passage.

During operation of the turbine engine 410, an initial airflow or an incoming airflow passes through the fan blades 454 of the fan 452 and splits into a first airflow and a second airflow. The first airflow bypasses the engine inlet 482 and flows generally along the axial direction A outward of the fan cowl 470 along the radial direction R. The first airflow accelerated by the fan blades 454 passes through the fan guide vanes 462 and continues downstream thereafter to produce a primary propulsion stream or a first thrust stream S1. A majority of the net thrust produced by the turbine engine 410 is produced by the first thrust stream S1. The second airflow enters the inlet duct 480 through the engine inlet 482.

The second airflow flowing downstream through the inlet duct 480 flows through the plurality of mid-fan blades 488 of the mid-fan 486 and is consequently compressed. The second airflow flowing downstream of the mid-fan blades 488 is split by the splitter 484 located at the forward end of the core cowl 422. Particularly, a portion of the second airflow flowing downstream of the mid-fan 486 flows into the core duct 442 through the core inlet 424. The portion of the second airflow that flows into the core duct 442 is progressively compressed by the LP compressor 426 and the HP compressor 428, and is ultimately discharged into the combustion section. The discharged pressurized air stream flows downstream to the combustor 430 where fuel is introduced to generate combustion gases or products.

The combustor 430 defines an annular combustion chamber that is generally coaxial with the longitudinal centerline axis 412. The combustor 430 receives pressurized air from the HP compressor 428 via a pressure compressor discharge outlet. A portion of the pressurized air flows into a mixer. Fuel is injected by a fuel nozzle (omitted for clarity) to mix with the pressurized air and forming a fuel-air mixture that is provided to the combustion chamber for combustion. Ignition of the fuel-air mixture is accomplished by one or more igniters (omitted for clarity), and the resulting combustion gases flow along the axial direction A toward, and into, a first stage turbine nozzle 433 of the HP turbine 432. The first stage turbine nozzle 433 is defined by an annular flow channel that includes a plurality of radially extending, circumferentially spaced nozzle vanes 435 that turn the combustion gases so that the combustion gases flow angularly and impinge upon first stage turbine blades of the HP turbine 432. The combustion gases exit the HP turbine 432 and flow through the LP turbine 434, and exit the core duct 442 through the core exhaust nozzle 440 to produce a core air stream, also referred to as a second thrust stream S2. As noted above, the HP turbine 432 drives the HP compressor 428 via the HP shaft 436, and the LP turbine 434 drives the LP compressor 426, the fan 452, and the mid-fan 486 via the LP shaft 438.

The other portion of the second airflow flowing downstream of the mid-fan 486 is split by the splitter 484 into the fan duct 472. The air enters the fan duct 472 through the fan duct inlet 476. The air flows generally along the axial direction A through the fan duct 472 and is ultimately exhausted from the fan duct 472 through the fan exhaust nozzle 478 to produce a third stream, also referred to as a third thrust stream S3.

The third thrust stream S3 is a secondary air stream that increases fluid energy to produce a minority of total propulsion system thrust. In some embodiments, a pressure ratio of the third stream is higher than that of the primary propulsion stream (e.g., a bypass or a propeller driven propulsion stream). The thrust may be produced through a dedicated nozzle or through mixing of the secondary air stream with the primary propulsion stream or a core air stream, e.g., into a common nozzle. In certain embodiments, an operating temperature of the secondary air stream is less than a maximum compressor discharge temperature for the engine. Furthermore, in certain embodiments, aspects of the third stream (e.g., airstream properties, mixing properties, or exhaust properties), and, thus, a percent contribution to total thrust, are passively adjusted during engine operation or can be modified purposefully through the use of engine control features (such as fuel flow, electric machine power, variable stators, variable inlet guide vanes, valves, variable exhaust geometry, or fluidic features) to adjust or to improve overall system performance across a broad range of potential operating conditions.

The turbine engine 410 depicted in FIG. 4 is by way of example only. In other embodiments, the turbine engine 410 may have other suitable configurations. For example, the fan 452 can be ducted by a fan casing or a nacelle such that a bypass passage is defined between the fan casing and the fan cowl 470. Moreover, in other embodiments, any other suitable number or configuration of compressors, turbines, shafts, or a combination thereof may be provided. In still other embodiments, aspects of the present disclosure may be incorporated into any other suitable turbine engine, such as, for example, turbine engines defining two streams (e.g., a bypass stream and a core air stream).

Further, for the depicted embodiment of FIG. 4, the turbine engine 410 includes an electric machine 490 (e.g., a motor-generator) operably coupled with a rotating component thereof. In this regard, the turbine engine 410 is a hybrid-electric propulsion machine. Particularly, as shown in FIG. 4, the electric machine 490 is operatively coupled with the LP shaft 438. The electric machine 490 can be mechanically connected to the LP shaft 438, either directly, or indirectly, e.g., by way of a gearbox assembly 492 (shown schematically in FIG. 4). Further, although, in this embodiment the electric machine 490 is operatively coupled with the LP shaft 438 at an aft end of the LP shaft 438, the electric machine 490 can be coupled with the LP shaft 438 at any suitable location or can be coupled to other rotating components of the turbine engine 410, such as the HP shaft 436 or the LP shaft 438. For instance, in some embodiments, the electric machine 490 can be coupled with the LP shaft 438 and positioned forward of the mid-fan 486 along the axial direction A. In some embodiments, the turbine engine of FIG. 1 also includes an electric machine coupled to the LP shaft and located in the tail cone of the engine.

In some embodiments, the electric machine 490 can be an electric motor operable to drive or to motor the LP shaft 438. In other embodiments, the electric machine 490 can be an electric generator operable to convert mechanical energy into electrical energy. In this way, electrical power generated by the electric machine 490 can be directed to various engine systems or aircraft systems. In some embodiments, the electric machine 490 can be a motor/generator with dual functionality. The electric machine 490 includes a rotor 494 and a stator 496. The rotor 494 is coupled to the LP shaft 438 and rotates with rotation of the LP shaft 438. In this way, the rotor 494 rotates with respect to the stator 496, generating electrical power. Although the electric machine 490 has been described and illustrated in FIG. 4 as having a particular configuration, the present disclosure may apply to electric machines having alternative configurations. For instance, the rotor 494 or the stator 496 may have different configurations or may be arranged in a different manner than illustrated in FIG. 4.

The turbine engine 410 also includes a controller 498 similar to the controller 190 of FIG. 1. The turbine engine 410 also includes a fuel system (not shown in FIG. 4 for clarity) for delivering the fuel to the combustor 430 similar to the fuel system 180 of FIG. 1.

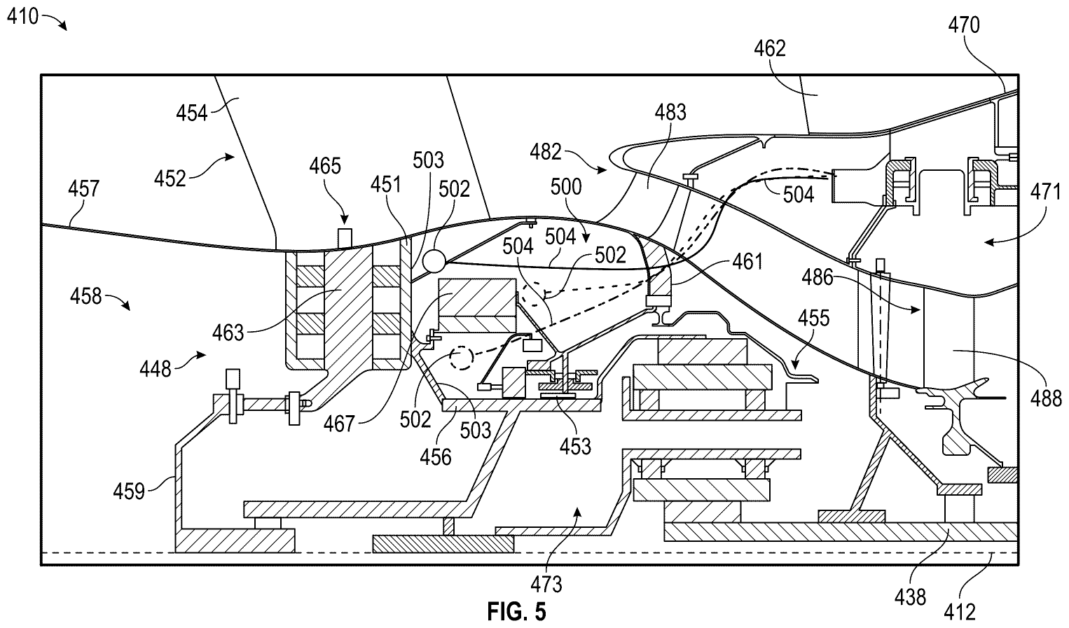

FIG. 5 is a partial schematic cross-sectional diagram of the turbine engine 410, taken at detail 5 in FIG. 4, with a fan speed sensor system 500, according to the present disclosure. The fan speed sensor system 500 is substantially similar to the fan speed sensor system 200 of FIG. 2. The same or similar reference numerals will be used for components of the fan speed sensor system 500 that are the same as or similar to the components of the fan speed sensor system 200 discussed above, unless stated otherwise. The description of these components above also applies to this embodiment, and a detailed description of these components is omitted here.

As shown in FIG. 5, the fan 452 includes a fan rotor assembly 448 that includes the fan disk 451. The fan cowl 470 (e.g., the outer casing) includes a hollow interior 471. The engine inlet 482 includes an inlet guide vane 483 that guides the core air into the turbo-engine 420. The gearbox assembly 455 is coupled to the fan frame flange 461 such that the fan frame 460 supports the gearbox assembly 455. The fan frame flange 461 rotationally supports the fan shaft 456 via one or more bearings 453. The turbine engine 410 also includes a lubricant sump 473 (e.g., an oil wetted bearing sump) that is positioned about the gearbox assembly 455. The fan actuation system 458 includes a plurality of trunnions 463 (one shown in FIG. 5) that is coupled to the plurality of fan blades 454. The fan blades 454 can be coupled to the trunnions 463 by a removable fastener 465, such as, for example, a pin and a snap ring that holds the pin in place, a bolt, or the like. In some embodiments, the fan blades 454 and the trunnions 463 are integrally formed as a single, integral component. The plurality of trunnions 463 is rotationally mounted within the fan disk 451. The plurality of trunnions 463 is coupled to the actuators 459 by, for example, a pin, or the like. In some embodiments, the trunnions 436 include a dovetail and the dovetail is mounted into a corresponding slot and are coupled with a removable fastener, such as, for example, a snap ring, a bolt, a nut, a split collet, or the like. The plurality of trunnions 463 rotates about the pitch axis P (FIG. 4) with respect to the fan disk 451 to adjust the pitch of the plurality of fan blades 454.

The fan actuation system 458 also includes a counterweight 467 positioned aft of the fan disk 451 that helps adjust the pitch of the plurality of fan blades 454 under high loads (e.g., loads during high-power operation, such as takeoff conditions) on the plurality of fan blades 454. The fan actuation system 458 can also be utilized in the turbine engine 110 of FIGS. 1 and 2. The fan 452 includes a fan rotor assembly 448 that includes the fan disk 451. The fan rotor assembly 448 also includes the fan shaft 456 and the counterweight 467.

The fan speed sensor system 500 includes one or more fan speed sensors 502 that sense a reference point 503 on the fan rotor assembly 448 (e.g., the fan disk 451, the fan shaft 456, or the counterweight 467). Each of the one or more fan speed sensors 502 includes a cable 504. The one or more fan speed sensors 502 are preferably disposed aft of the fan rotor assembly 448 and are oriented to sense the fan rotor assembly 448. In particular, the one or more fan speed sensors 502 are positioned to send the fan disk 451 (e.g., the reference point 503 on the fan disk 451). In some embodiments (shown by dashed lines in FIG. 5), the one or more fan speed sensors 502 are positioned to sense the fan shaft 456 (e.g., the reference point 503 on the fan shaft 456). In some embodiments (shown by dashed lines in FIG. 5), the one or more fan speed sensors 502 are positioned to sense the counterweight 467 (e.g., the reference point 503 on the counterweight 467). In this way, the one or more fan speed sensors 502 sense at least one of the fan disk 451, the fan shaft 456, or the counterweight 467.

When the one or more fan speed sensors 502 sense the fan disk 451, the one or more fan speed sensors 502 can sense the plurality of trunnions 463. For example, the one or more fan speed sensors 502 can sense a magnetic pickup on the plurality of trunnions 463 to determine a pitch angle, also referred to as a blade beta angle, of the plurality of fan blades 454. The pitch angle is an angle of the pitch of the plurality of fan blades 454. The pitch angle (blade beta angle) is measured as an instantaneous angle that a chord of the fan blades 454 makes with a predetermined reference point. In particular, the blade beta angle is measured at a root of the fan blade 451. In some embodiments, the predetermined reference point is in a static frame of reference (e.g., forward or aft) such that the fan blade sensors 502 sense the predetermined reference point as the predetermined reference point rotates past the fan speed sensors 502. In some embodiments the predetermined reference point is in a rotating frame of reference such that the fan speed sensors 502 are mounted on the fan rotor assembly 448 and sense the predetermined reference point on a static component as the fan speed sensors 502 rotate past the predetermined reference point.

The one or more fan speed sensors 502 sense a change in a magnetic field of the plurality of trunnions 463 (e.g., of the magnetic pickup) as the plurality of trunnions 463 adjusts the pitch of the plurality of fan blades 454. The one or more fan speed sensors 502 generate a signal indicative of the pitch angle based on the change in the magnetic field and sends the signal indicative of the pitch angle to the controller 498 (or to a portion of the controller 498 or to another controller). The controller 498 (FIG. 4) receives the signal indicative of the pitch angle and determines the pitch angle of the plurality of fan blades 454 based on the signal indicative of the pitch angle. The controller 498 can control a slew rate (e.g., a rate of change) of the plurality of fan blades 454 based on the pitch angle and the fan speed, as detailed further below. In some embodiments, the controller 498 uses the sensed pitch angle to adjust the pitch of the fan blades 454 until the sensed pitch angle substantially equals a desired pitch angle. The controller 498 determines the desired pitch angle based on a corrected fan speed of the fan 452, and the controller 498 determines the corrected fan speed based on a throttle position of a throttle as set by a user (e.g., a pilot).

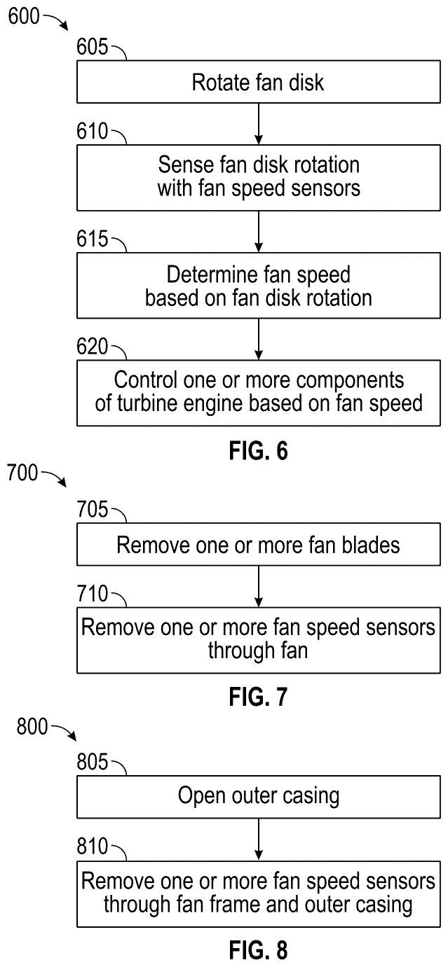

FIG. 6 is a flowchart of a method 600 of operating the fan speed sensor system 200 of the turbine engine 110, according to the present disclosure. While reference is made to the fan speed sensor system of FIG. 2, the method 600 can also be utilized for the fan speed sensor systems 300 and 500, respectively.

In step 605, the method 600 includes rotating the fan disk 142 (e.g., the fan rotor assembly 139). For example, as the turbine engine 110 operates, the fan shaft 145 rotates and causes the fan disk 142 to rotate, as detailed above with respect to FIG. 1.

In step 610, the method 600 includes sensing the rotation of the fan disk 142 (e.g., the fan rotor assembly 139) with the one or more fan speed sensors 202. The one or more fan speed sensors 202 sense the rotation of the fan rotor assembly 139, detailed above with respect to FIG. 2. For example, the one or more fan speed sensors 202 sense a reference point 203 (e.g., a phonic wheel, a magnetic pickup, a visual reference point, or the like). The one or more fan speed sensors 202 generate a signal indicative of the fan speed based on the sensed reference point 203.

In step 615, the method 600 includes determining the fan speed of the fan 138 based on the rotation of the fan rotor assembly 139. The controller 190 (FIG. 1) determines the fan speed of the fan 138 based on the rotation of the fan rotor assembly 139, as detailed above with respect to FIG. 2. For example, the fan speed sensors 202 send the signal indicative of the fan speed to the controller 190, and the controller 190 determines the fan speed based on the signal.

In step 620, the method 600 includes controlling one or more components of the turbine engine 110 based on the fan speed of the fan 138. For example, the controller 190 controls the fuel system 180 (FIG. 1) to control a fuel flow rate of the fuel to the combustor 126 (FIG. 1). In particular, the controller 190 controls the fuel system 180 to reduce the fuel flow rate if the fan speed is above a fan speed threshold. In some embodiments, the controller 190 controls the slew rate of the plurality of fan blades 140 based on the fan speed of the fan 138 when the controller 190 adjusts the pitch of the plurality of fan blades 140. In particular, the controller 190 modifies the slew rate of the plurality of fan blades 140 in response to a rate of change of speed or in response to an absolute value of speed of the fan 138. Thus, the method 600 includes controlling at least one of the fuel flow rate of the fuel or the slew rate of the plurality of fan blades 140 based on the fan speed of the fan 138. In an open fan engine (e.g., the turbine engine 410), the controller 190 can also control at least one of a pitch angle of one or more inlet guide vanes (e.g., the struts 474), an area of the fan exhaust nozzle 478, or an angular position of the fan guide vanes 462.

FIG. 7 is a flowchart of a method 700 of removing the one or more fan speed sensors 202 of the fan speed sensor system 200 from the turbine engine 110, according to the present disclosure. While reference is made to the fan speed sensor system 200 of FIG. 2, the method 700 can also be utilized for the fan speed sensor systems 300 and 500, respectively.

In step 705, the method 700 includes removing one or more of the plurality of fan blades 140. For example, a user (e.g., a technician) can remove the fan blades 140. This exposes an aperture within the fan 138 that leads to the one or more fan speed sensors 202. In this way, the one or more fan speed sensors 202 become exposed. With reference to FIG. 5, to remove the fan blades 454, the user can remove the removable fastener 465 and remove the fan blades 454 from the trunnions 463. In embodiments that include the trunnions 463 integral with the fan blades 140, the user can remove bearings about the trunnions 463 through a forward side or an aft side of the trunnions 463, and then can remove the fan blades 454 and the trunnions 463 together from the fan disk 451. In some embodiments, the user can remove the removable fastener that secures the dovetail of the trunnions 463 and then can remove the fan blades 454.

In step 710, the method 700 includes removing the one or more fan speed sensors 202 from the turbine engine 110 through the aperture. Thus, a user can access the one or more fan speed sensors 202 through the aperture, and can remove the one or more fan speed sensors 202 without having to remove additional components of the turbine engine 110. For example, the user can unplug the fan speed sensors 202 from the cable 204 to remove the fan speed sensors 204. In some embodiments, the fan speed sensors 202 are secured by a fastener (e.g., a bolt, a screw, or the like), and the user can remove the fastener to remove the one or more fan speed sensors 202.

In some embodiments, the method 700 includes installing the one or more fan speed sensors 202 by removing one or more of the plurality of fan blades 140 and installing the one or more fan speed sensors 202 from a forward end of the turbine engine 110.

FIG. 8 is a flowchart of a method 800 of removing the one or more fan speed sensors 202 of the fan speed sensor system 200 from the turbine engine 110, according to another embodiment. While reference is made to the fan speed sensor system 200 of FIG. 2, the method 800 can also be utilized for the fan speed sensor systems 300 and 500, respectively.

In step 805, the method 800 includes opening the outer casing 118. The outer casing 118, also referred to as a core cowl, can include a hinged structure that includes a hinge on a first side (e.g., at a twelve o'clock position) of the core cowl, and a removable fastener on a second side opposite the first side (e.g., at a six o'clock position) of the core cowl. The user can remove the removable fastener and open the core cowl about the hinge such that the user can access inside the fan frame 151. In some embodiments, the core cowl can be a fixed cowl such that the core cowl does not include a hinged feature. In such embodiments, the user can open the outer casing 118 by an access port in the core cowl that can be removed using, for example, removable fasteners (e.g., screws that are flush with the surface of the core cowl). Opening the outer casing 118 exposes an aperture within the fan frame 151 that leads to the cable 204 of the one or more fan speed sensors 202. In this way, the cable 204 becomes exposed.

In step 810, the method 800 includes removing the one or more fan speed sensors 202 from the turbine engine 110 through the fan frame 151 and the outer casing 118. For example, the user can remove the fan speed sensors 202 through the aperture in the within the fan frame 151. In embodiments that include the cable 204 routed through the inlet guide vane 123, the user can remove the speed sensors 202 through the inlet guide vane 123. In the embodiment of FIG. 3, step 815 includes removing the one or more fan speed sensors 302 from the sensor housing 305 and through the cable guide tube 306.

Accordingly, the fan speed sensor systems 200, 300, 500 herein include fan speed sensors 202, 302, 502 positioned to sense the fan rotor assembly 200, 300, 500 of the fan 138, 452 for sensing the fan speed. In this way, the one or more fan speed sensors 202, 302, 502 that are positioned outside (e.g., radially outward) of the lubricant sump 149, 473, and the lubricant sump 149, 473 does not need to be scaled up. Thus, the fan speed sensor systems 200, 300, 500 of the present disclosure can fit within the tight space of the integral drive engine without affecting the aerodynamic performance of the turbine engine to by having to change at least one of the overall length of the turbine engine, the fan radius ratio, or the fan diameter to fit the fan speed sensors 202, 302, 502 within the tight packaging of the turbine engine.

Further aspects are provided by the subject matter of the following clauses.

A turbine engine comprising a fan including a fan rotor assembly having a plurality of fan blades coupled to a fan disk, a fan frame that supports the fan, and a fan speed sensor system comprising one or more fan speed sensors that sense a fan speed of the fan, the one or more fan speed sensors being positioned to sense the fan rotor assembly.

The turbine engine of the preceding clause, wherein the one or more fan speed sensors are positioned axially between the fan rotor assembly and the fan frame.

The turbine engine of any preceding clause, wherein the fan includes a fan shaft coupled to the fan disk, and the one or more fan speed sensors are positioned to sense the fan shaft.

The turbine engine of any preceding clause, wherein the one or more fan speed sensors each includes a cable that extends from the one or more fan speed sensors through the fan frame.

The turbine engine of any preceding clause, further comprising an inlet guide vane, wherein the one or more fan speed sensors each includes a cable that extends from the one or more fan speed sensors through the inlet guide vane.

The turbine engine of any preceding clause, wherein the fan speed sensor system further includes a controller that determines the fan speed from the one or more fan speed sensors.

The turbine engine of any preceding clause, wherein the one or more fan speed sensors are positioned to sense the fan disk.

The turbine engine of any preceding clause, further comprising a fan actuation system including a plurality of trunnions that rotates the plurality of fan blades for adjusting a pitch of the plurality of fan blades.

The turbine engine of the preceding clause, wherein the one or more fan speed sensors sense the plurality of trunnions to determine a pitch angle of the plurality of fan blades.

The turbine engine of any preceding clause, wherein the fan actuation system includes a counterweight, and the one or more fan speed sensors are positioned to sense the counterweight.

The turbine engine of any preceding clause, further comprising a lubricant sump and one or more bearings, the lubricant sump collecting lubricant from the one or more bearings, wherein the one or more fan speed sensors are positioned radially outward of the lubricant sump.

The turbine engine of the preceding clause, further comprising a turbo-engine having a low-pressure shaft and a gearbox assembly, wherein the fan includes a fan shaft that is coupled to the low-pressure shaft through the gearbox assembly.

The turbine engine of any preceding clause, wherein the one or more fan speed sensors are positioned axially forward of the gearbox assembly.

The turbine engine of any preceding clause, wherein the fan rotor assembly includes a reference point, and the one or more fan speed sensors sense the reference point.

The turbine engine of the preceding clause, wherein the reference point includes at least one of a phonic wheel, a magnetic pickup, or a visual reference point.

The turbine engine of any preceding clause, wherein the fan frame includes a fan frame flange.

The turbine engine of any preceding clause, wherein the one or more fan speed sensors are positioned axially between the fan disk and the fan frame flange.

The turbine engine of any preceding clause, wherein the cable extends through the fan frame flange.

The turbine engine of any preceding clause, wherein the fan speed sensor system includes a cable guide tube, the cable extending through the cable guide tube.

The turbine engine of any preceding clause, wherein the fan speed sensor system includes a sensor housing, the one or more fan speed sensors being disposed within the sensor housing.

The turbine engine of the preceding clause, wherein the sensor housing is removably coupled to the fan frame.

The turbine engine of the preceding clause, wherein the fan frame includes a fan frame flange, and the sensor housing is removably coupled to the fan frame flange.

A method of operating the turbine engine of any preceding clause, the method comprising rotating the fan rotor assembly, sensing rotation of the fan rotor assembly with the one or more fan speed sensors, determining the fan speed of the fan based on the rotation of the fan rotor assembly, and controlling one or more components of the turbine engine based on the fan speed of the fan.

The method of the preceding clause, wherein controlling one or more components of the turbine engine includes controlling at least one of a fuel flow rate of the turbine engine or a slew rate of an adjustment of a pitch of the plurality of fan blades.

The method of any preceding clause, wherein the fan includes a fan shaft coupled to the fan disk, and the method further comprises sensing rotation of the fan shaft with the one or more fan speed sensors.

The method of any preceding clause, wherein the turbine engine includes a turbo-engine having a low-pressure shaft and a gearbox assembly, and the method further comprises transferring power from the low-pressure shaft to the fan through the gearbox assembly.

The method of any preceding clause, wherein the turbine engine includes a fan actuation system including a plurality of trunnions, and the method further comprises adjusting a pitch of the plurality of fan blades by rotating the plurality of trunnions.

The method of the preceding clause, further comprising sensing a rotation of the plurality of trunnions with the one or more fan speed sensors, and determining a pitch angle of the plurality of fan blades based on the rotation of the plurality of trunnions.

The method of any preceding clause, wherein the fan actuation system includes a counterweight, and the method further comprises sensing the counterweight with the one or more fan speed sensors.

The method of any preceding clause, wherein the one or more fan speed sensors are positioned axially between the fan disk and the fan frame.

The method of any preceding clause, wherein the one or more fan speed sensors each includes a cable that extends from the one or more fan speed sensors through the fan frame.

The method of any preceding clause, wherein the turbine engine includes an inlet guide vane, and the one or more fan speed sensors each includes a cable that extends from the one or more fan speed sensors through the inlet guide vane.

The method of any preceding clause, wherein the fan speed sensor system further includes a controller that determines the fan speed from the one or more fan speed sensors.

The method of the preceding clause, wherein the controller controls one or more components of the turbine engine based on the fan speed.

The method of any preceding clause, wherein the turbine engine includes a lubricant sump and one or more bearings, the lubricant sump collecting lubricant from the one or more bearings, wherein the one or more fan speed sensors are positioned radially outward of the lubricant sump.

The method of any preceding clause, wherein the one or more fan speed sensors are positioned axially forward of the gearbox assembly.

The method of any preceding clause, wherein the fan rotor assembly includes a reference point, and the method further comprises sensing the reference point with the one or more fan speed sensors.

The method of the preceding clause, wherein the reference point includes at least one of a phonic wheel, a magnetic pickup, or a visual reference point.

The method of any preceding clause, wherein the fan frame includes a fan frame flange.

The method of any preceding clause, wherein the one or more fan speed sensors are positioned axially between the fan disk and the fan frame flange.

The method of any preceding clause, wherein the cable extends through the fan frame flange.

The method of any preceding clause, wherein the fan speed sensor system includes a cable guide tube, the cable extending through the cable guide tube.

The method of any preceding clause, wherein the fan speed sensor system includes a sensor housing, the one or more fan speed sensors being disposed within the sensor housing.

The method of the preceding clause, wherein the sensor housing is removably coupled to the fan frame.

The method of the preceding clause, wherein the fan frame includes a fan frame flange, and the sensor housing is removably coupled to the fan frame flange.

A method of removing the one or more fan speed sensors of the turbine engine any of the preceding clause. The method includes removing the one or more of the plurality of fan blades to open an aperture, and removing the one or more fan speed sensors through the aperture.

A method of removing the one or more fan speed sensors of the turbine engine any of the preceding clause. The method includes opening the outer casing, opening the fan frame, and removing the one or more fan speed sensors through the fan frame and the outer casing.

The method of any preceding clause, wherein the fan frame includes a fan frame flange, and the method further comprises removing the one or more fan speed sensors through the fan frame flange.

The method of any preceding clause, wherein the fan speed sensor system includes a cable guide tube, and the method further comprises removing the one or more fan speed sensors through the cable guide tube.

The method of any preceding clause, wherein the fan speed sensory system includes a sensor housing, and the method further comprises removing the one or more fan speed sensors from the sensor housing.

The method of any preceding clause, wherein the turbine engine is the turbine engine of any preceding clause.

Although the foregoing description is directed to the preferred embodiments of the present disclosure, other variations and modifications will be apparent to those skilled in the art and may be made without departing from the disclosure. Moreover, features described in connection with one embodiment of the present disclosure may be used in conjunction with other embodiments, even if not explicitly stated above.

1. A turbine engine comprising:
a fan including a fan rotor assembly having a plurality of fan blades coupled to a fan disk;
a fan frame that supports the fan; and
a fan speed sensor system comprising one or more fan speed sensors that sense a fan speed of the fan, the one or more fan speed sensors being positioned to sense the fan rotor assembly.

2. The turbine engine of claim 1, wherein the one or more fan speed sensors are positioned axially between the fan rotor assembly and the fan frame.

3. The turbine engine of claim 1, wherein the fan includes a fan shaft coupled to the fan disk, and the one or more fan speed sensors are positioned to sense the fan shaft.

4. The turbine engine of claim 1, wherein the one or more fan speed sensors each includes a cable that extends from the one or more fan speed sensors through the fan frame.

5. The turbine engine of claim 1, further comprising an inlet guide vane, wherein the one or more fan speed sensors each includes a cable that extends from the one or more fan speed sensors through the inlet guide vane.

6. The turbine engine of claim 1, wherein the fan speed sensor system further includes a controller that determines the fan speed from the one or more fan speed sensors.

7. The turbine engine of claim 1, wherein the one or more fan speed sensors are positioned to sense the fan disk.

8. The turbine engine of claim 1, further comprising a fan actuation system including a plurality of trunnions that rotates the plurality of fan blades for adjusting a pitch of the plurality of fan blades.

9. The turbine engine of claim 8, wherein the one or more fan speed sensors sense the plurality of trunnions to determine a pitch angle of the plurality of fan blades.

10. The turbine engine of claim 8, wherein the fan actuation system includes a counterweight, and the one or more fan speed sensors are positioned to sense the counterweight.

11. The turbine engine of claim 1, further comprising a lubricant sump and one or more bearings, the lubricant sump collecting lubricant from the one or more bearings, wherein the one or more fan speed sensors are positioned radially outward of the lubricant sump.

12. The turbine engine of claim 11, further comprising a turbo-engine having a low-pressure shaft and a gearbox assembly, wherein the fan includes a fan shaft that is coupled to the low-pressure shaft through the gearbox assembly.

13. The turbine engine of claim 12, wherein the one or more fan speed sensors are positioned axially forward of the gearbox assembly.

14. A method of operating the turbine engine of claim 1, the method comprising:
rotating the fan rotor assembly;
sensing rotation of the fan rotor assembly with the one or more fan speed sensors;
determining the fan speed of the fan based on the rotation of the fan rotor assembly; and
controlling one or more components of the turbine engine based on the fan speed of the fan.

15. The method of claim 14, wherein controlling one or more components of the turbine engine includes controlling at least one of a fuel flow rate of the turbine engine or a slew rate of an adjustment of a pitch of the plurality of fan blades.

16. The method of claim 14, wherein the fan includes a fan shaft coupled to the fan disk, and the method further comprises sensing rotation of the fan shaft with the one or more fan speed sensors.

17. The method of claim 14, wherein the turbine engine includes a turbo-engine having a low-pressure shaft and a gearbox assembly, and the method further comprises transferring power from the low-pressure shaft to the fan through the gearbox assembly.

18. The method of claim 14, wherein the turbine engine includes a fan actuation system including a plurality of trunnions, and the method further comprises adjusting a pitch of the plurality of fan blades by rotating the plurality of trunnions.

19. The method of claim 18, further comprising sensing a rotation of the plurality of trunnions with the one or more fan speed sensors, and determining a pitch angle of the plurality of fan blades based on the rotation of the plurality of trunnions.

20. The method of claim 18, wherein the fan actuation system includes a counterweight, and the method further comprises sensing the counterweight with the one or more fan speed sensors.
